(19) United States
(12) Patent Application Publication
(10) Pub. No.: US 2023/0126225 A1
(43) Pub. Date: Apr. 27, 2023

(54) DYE SUBLIMATION PRINTING

(71) Applicant: Hewlett-Packard Development Company, L.P., Spring, TX (US)

(72) Inventors: Hector Jose LEBRON RODRIGUIZ, San Diego, CA (US); Raimon CASTELLS DE MONET, Sant Cugat del Valles (ES); Alberto BORREGO LEBRATO, Sant Cugat del Valles (ES)

(73) Assignee: Hewlett-Packard Development Company, L.P., Spring, TX (US)

(21) Appl. No.: 17/906,903

(22) PCT Filed: Mar. 23, 2020
(86) PCT No.: PCT/US2020/024236

§ 371 Date: Sep. 21, 2022

(51) Int. Cl. B41M 5/382

(52) U.S. Cl. CPC B41M 5/38242; B41M 2205/02

(57) ABSTRACT

A printing apparatus comprises a depositing device and a sublimation device. The depositing device may deposit a print fluid on a first surface of a print medium. The print fluid comprises a sublimation agent to sublimate at a sublimation temperature. The sublimation device may sublimate the sublimation agent deposited on the print medium by generating heat radiation in a direction from a second surface of the print medium towards the first surface, the second surface being opposite to the first surface.

### BACKGROUND

Dye sublimation printing refers to a printing technology of depositing a print fluid on a substrate and sublimating the print fluid to fix to the substrate. The sublimation may refer to a transition from a solid state into a gaseous state without passing through the liquid state. The sublimation may occur under specific conditions in particular including pressure and temperature. Usually, heat is applied to the print fluid to cause the sublimation.

### BRIEF DESCRIPTION OF THE DRAWINGS

In the following description and in the drawings, same reference signs are used to indicate same or similar structural or functional features.

FIG. 1 is a schematic diagram of a printing apparatus according to an example.

FIG. 2 is a schematic diagram of a printing apparatus according to another example.

FIG. 3 is a schematic diagram of a printing apparatus according to a further example.

FIG. 4 is a schematic diagram of a printing apparatus according to a further example.

FIG. 5 is a schematic diagram of a printing apparatus according to a further example.

FIG. 6 is a schematic diagram of a printing apparatus according to a further example

FIG. 7 is a schematic diagram of a printing apparatus according to a further example.

FIG. 8 is a schematic diagram of a printing apparatus according to a further example.

FIG. 9 is a schematic diagram of a printing apparatus according to still a further example.

FIG. 10 is a flow diagram of a method according to an example.

FIG. 11 shows diagrams of end temperatures of different types of sublimation agents according to an example.

### DETAILED DESCRIPTION

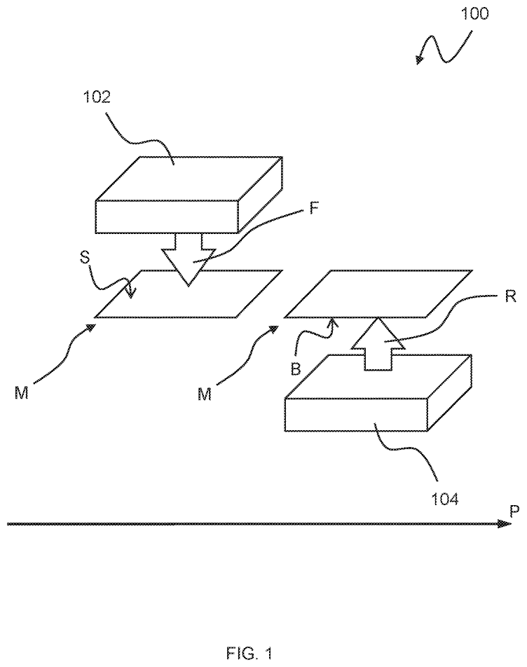

FIG. 1 schematically shows a printing apparatus 100 comprising a depositing device 102 and a sublimation device 104. The printing apparatus 100 may be a single device, or a system or an arrangement comprising multiple devices operable to print an image on a print medium M.

In the drawings, an arrow P depicts a progress of operation of the printing device or a progress of a method. The printing apparatus 100 may be operable to transport the print medium M between the depositing device 102 and the sublimation device 104. Alternatively or additionally, the depositing device 102 and the sublimation device 104 may be operable to process the print medium with the print medium M in place. The depositing device 102 and the sublimation device 104 may be arranged immovably, or at least one of the depositing device 102 and the sublimation device 104 may be movable relative to the print medium M during operation. The depositing of the print fluid F and the sublimation of the sublimation agent may be carried out at different locations or at the same location within the printing apparatus 100.

The print medium M may be a target product on which an image is to be printed. Alternatively, the print medium M may be a transfer medium to transfer an image onto a target product. The printing apparatus 100 may be operable with either one or both of these types of the print medium.

The print medium M may also be referred to as a substrate in the following. The print medium M is not limited to a specific material. In some examples, the print medium M may comprise at least one of a textile including polyester fabrics, paper, cardboard or polymer material. Further, the print medium may M refer to a polymer-based coating for a solid body. The print medium M may provide a surface S on which a print fluid F is to be deposited.

The print fluid F may comprise at least one of a pigment, a colorant and a dye. The print fluid F may contain substances of a single color or multiple different colors. Further, the printing apparatus 100 may use multiple print fluids corresponding to a respective color. The print fluid F may comprise a sublimation agent which is or contains the at least one of a pigment, colorant and dye, or the like. In some examples, the sublimation agent may be or contain a sublimation dye or a sublimation colorant. The sublimation agent may be a solid dispersion in the print fluid F. Alternatively or additionally, the sublimation agent may be at least partially solved in a liquid phase of the print fluid F.

The sublimation agent may be provided to change from the solid phase to the gaseous state convergent, or coherent, with the thermal performance of the print medium M, thereby allowing the gaseous sublimation agent to migrate into internal structures, such as polyester fibers, of the print medium M. Some specific examples of the sublimation agent that are commercially available include, without being limited to, Disperse Yellow 54, Disperse Red 60, Disperse Red 71, Disperse Red 63, Disperse Blue 359, Disperse Blue 360, Disperse Brown 27, Disperse Red 364, Solvent Yellow 114 and Solvent Red 146.

The sublimation agent as used herein may refer to a sublimation dye of a respective color. The sublimation agent may change from a solid state into a gaseous state, and vice versa, without passing a liquid state. The transition from the solid state into the gaseous state without passing a liquid state or vice versa may be referred to as sublimation. The print fluid F may further comprise an equalizer agent to homogenize the absorbance of light among different sublimation agents.

The sublimation may occur under predefined conditions including a pressure and a temperature applied to the sublimation agent or the print fluid F. The pressure may the atmospheric pressure or at 1000 hPa. For example, the sublimation agent may sublimate at a temperature above 50° C., above 100° C., above 150° C., or above 180° C., or above 200° C., and below 400° C., or below 300° C., or below 280° C. In some examples, the sublimation agent may sublimate at about 200° C. to 250° C., or around 220° C. The temperature at which the sublimation agent sublimates is referred to herein as a sublimation temperature. In some examples, the sublimation agent may be provided as particles, and the sublimation temperature may depend on the size of the particles of the sublimation agent. The sublimation temperature may increase with increasing size of the sublimation agent particles. In examples where the particle size of the sublimation agent is distributed over a range, a degree of sublimation may increase with increasing applied temperature. For example, the sublimation of the sublimation agent may begin, i.e. the smallest sublimation agent particles may sublimate, at a temperature of 100° C., and a full sublimation may be achieved at or above 210° C. A range of the sublimation temperature may vary depending on at least one of material and size of the sublimation agent. Furthermore, the sublimation temperature may be lowered by decreasing an applied pressure. While the sublimation temperature may also be affected by a relative humidity, which may be between 20 and 80%, the effect of the humidity on the sublimation agent may be negligible.

The depositing device 102 may deposit the print fluid F on the surface S of the print medium M. For example, the printing apparatus 100 may comprise or be connected to a print fluid container (not shown) storing the print fluid F. The depositing device 102 may receive the print fluid F from the print fluid container and deposit the print fluid F on the print medium M, in particular on the surface S, using nozzles. Any other mechanism for depositing the print fluid F on the print medium M may be used in addition or alternatively.

The depositing device 102 may deposit the print fluid F containing the sublimation agent on the print medium M according to the image to be printed. The printing device 100 may use a set of different sublimation agents, each sublimation agent being representative for a respective print color. The different sublimation agents may be distributed arbitrarily on the print medium M and may be deposited in variable intensity, controllable by a deposition thickness.

The printing device 100 may comprise a controller (not shown) to control the depositing device 102 to deposit the print fluid F on the print medium M according to an image that is to be printed on the print medium M. Furthermore, the printing device 100 may comprise an input device (not shown) to receive the image to be printed. The printing device 100 may comprise a memory device (not shown) to store settings for printing processes.

The sublimation device 104 may be operable to sublimate the sublimation agent deposited on the print medium by generating heat radiation R. The heat radiation R may be generated in a direction from a backside B of the print medium M towards the surface S, with the backside B being opposite to the surface S. The surface S also is referred to as a first surface S and the backside surface B also is referred to as second surface B. In particular, the heat radiation R may be generated such that heat radiation propagates from the backside B of the print medium M towards the surface S of the print medium M. In some examples, the heat radiation R may be generated on the side opposite to the surface S on which the print fluid F is deposited.

The sublimation device 104 may include a light source to generate the heat radiation R. The heat radiation R may be generated in a wavelength range within at least one of ultraviolet, infrared, near-infrared or visible, or any combination thereof. It particular, the heat radiation R may be generated in a wavelength range in which a light absorbance of the sublimation agent is non-zero, or even has a (local) maximum radiation absorbance. The sublimation device 104 may be operable to generate the heat radiation R in different wavelength ranges. For example, the sublimation device 104 may switch between the different wavelength ranges depending on the print fluid F that has been deposited on the print medium M. Furthermore, the sublimation device 104 may comprise multiple light sources to generate the heat radiation R in multiple wavelength ranges. For example, the multiple wavelength ranges may correspond to the absorption maxima of different sublimation agents used by the printing device 100. Additionally or alternatively, the sublimation device 104 may generate the heat radiation R within a wavelength range within, overlapping or encompassing an absorption maximum of a material of the print medium M. This may expedite the absorption of the heat radiation R by the print medium M. In a specific example, the sublimation device 104 may generate the heat radiation R in a wavelength range near or overlapping an absorption maximum of polyester fibers.

In specific examples, the sublimation agent may have a radiation absorption maximum within an infrared wavelength range, for example within a MIR band, a NIR band or a FIR band, or within an ultraviolet wavelength range. The sublimation device 104 may comprise a light source adapted to generate the heat radiation R inside or at least partially overlapping the respective wavelength range in which the absorption maximum of the sublimation agent lies. For example, the sublimation device 104 may include an MIR band emitter, such as a ceramic lamp.

The heat radiation R may cause the sublimation agent of the print fluid F deposited on the print medium M to sublimate. The amount of heat or energy from the heat radiation R of the sublimation device 104 that is absorbed by the sublimation agent of the print fluid F may be sufficient to change into the gaseous state. In particular, the sublimation device 104 may generate and apply the heat radiation R such to increase the temperature of the sublimation agent to be at or above the sublimation temperature. As such, the heat applied or transferred to the sublimation agent (or the print fluid F) may also be referred to as sublimation heat.

The sublimation device 104 may be operable to generate the heat radiation R such to expose the print medium M to the heat radiation R for a predetermined period of time, which may be referred to as an irradiation time. The irradiation time may be determined to cause a target amount of the sublimation agent of the print fluid F deposited on the print medium M to sublimate. The irradiation time may be an empiric value. The target amount of the sublimation agent to sublimate may be at least 8o wt. %, at least 90 wt. %, or at least 95 wt. % of the total amount of the deposited sublimation agent.

The irradiation time may depend on parameters, which may include, for example, an intensity or power of the generated heat radiation, the wavelength range in which the heat radiation R is generated, and the distance between the source of the heat radiation R the print medium M and an expected temperature of the print medium M during irradiation. The irradiation time may vary depending on the print fluid F that has been deposited on the print medium M. The irradiation time may be between 1 millisecond and 100 seconds, between 1 millisecond and 50 seconds, or between 1 millisecond and 10 seconds. In specific examples, the print medium M may be exposed to the heat radiation R generated by the sublimation device 104 for up to 5 seconds, up to 2 seconds, or around 1 second.

As described above, the depositing device 102 may deposit the print fluid F containing the sublimation agent according to the image to be printed on the print medium M. The sublimation agent may be used to visualize a print area with a respective color on the print medium M. The deposition intensity, which is quantified by a thickness of the sublimation agent deposited in a unit area of the print medium M, and a color distribution, which may correspond to the distribution of different sublimation agents, may vary over the print medium M according to the image to be printed.

In some examples, the sublimation agent of the print fluid F deposited on the print medium M may be in a solid state until exposed to the heat radiation R of the sublimation device 104. The sublimation agent may sublimate as a result of being exposed to the heat radiation generated R by the sublimation device 104. The gaseous sublimation agent may diffuse into the print medium M. Then, the sublimation device 104 may terminate the heat radiation R, for example after the irradiation time has elapsed. Additionally or alternatively, the print medium M may be moved away from the sublimation device 104 after being exposed for a duration in a similar manner to the irradiation time as described above.

Accordingly, the temperature of the print medium M and the sublimation agent of the print fluid F may fall below the sublimation temperature of the sublimation agent. As a result, the sublimation agent may change into the solid state. Since the sublimation agent in the gaseous state has diffused into the print medium M, the transition into the solid state may result in the sublimation agent being fixed to a microscopic internal structure of the print medium M. The microscopic internal structure may refer to a physical structure on a scale of 0.1 μm to 1 mm, 0.1 μm to 0.1 mm, or 0.1 μm to 10 μm. The microscopic internal structure may include fabrics, fibers, a web, a network, etc.

With the sublimation agent containing or being a pigment, colorant, dye or the like as described above, the image may be printed on the print medium M when the sublimation agent is fixed to the print medium M in the solid state.

In the printing device 100, the heat radiation R first propagates through the print medium M and is partly absorbed by the print medium M, thereby heating the print medium M as a result. The remaining, unabsorbed part of the heat radiation R reaches the surface S of the print medium M and may be partly absorbed by the sublimation agent deposited thereon. Accordingly, heat from the heat radiation R generated by the sublimation device 104 may be transferred to the sublimation on the one hand via direct absorption of the radiation and, on the other hand, via thermal conduction through the print medium M. In other words, the heat radiation R is split into at least two different heat transfer mechanisms. In particular, a relatively large portion of the energy from the heat radiation R is absorbed by the print medium M and can be transferred to the sublimation agent by thermal conduction. Accordingly, any effect caused by a wavelength-dependency of the absorbance of the sublimation agent may be diminished.

This may result in a uniform absorbance of the heat radiation R and thus uniform temperature distribution among different sublimation agents of different colors. Namely, the absorbance properties may vary among sublimation agents of different colors for a given wavelength of the heat radiation R, which may lead to a non-uniform temperature distribution including high temperature gradients occurring across the image.

Furthermore, depending on the image to be printed, the intensity, which may be quantified by a deposition thickness, of the sublimation agent on the print medium M may vary over the print medium M. A thick layer of the deposited sublimation agent may correspond to a high intensity of a respective color and may absorb differently than a thin deposition layer. This distribution of the deposition thickness of the sublimation agent on the print medium M may also lead to a non-uniform distribution of temperature after exposure to the heat radiation R of the sublimation device 104. Such temperature gradients may also occur between a printed area and an unprinted area of the print medium M.

By converting a portion of the heat radiation R into heat absorbed by the print medium M to be transferred to the sublimation agent as described above, the non-uniformity of temperature over the print medium M due to a color or deposition thickness distribution of the sublimation agent may be reduced. This may result in increasing the quality of the image printed on the print medium M. Moreover, the reduction of the non-uniformity of the temperature may lead to reducing wrinkles and warpages which may result from large temperature gradients over the print medium M.

Moreover, the sublimation device 104 including the structural means for generating and applying the heat radiation for the sublimation of the sublimation agent may be provided within a common housing with the depositing device 102. Accordingly, when compared in particular with hot rotary presses as in calendaring that requires a standalone arrangement for generating and applying heat for sublimation, space requirements may be decreased, and also a throughput of the printing apparatus may be increased.

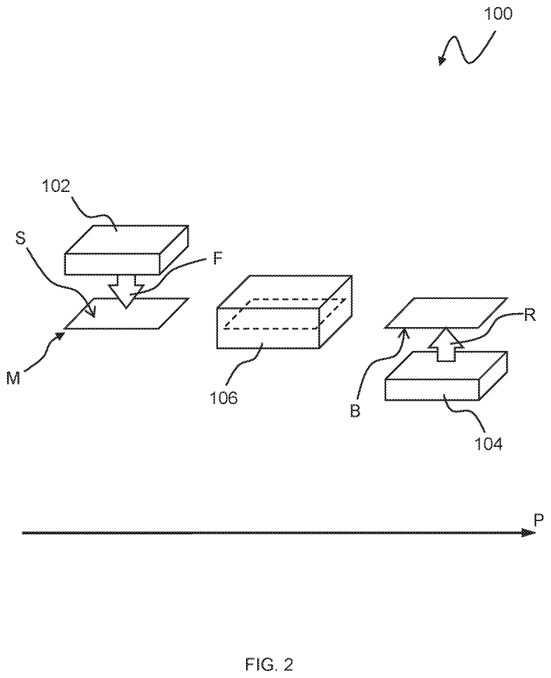

FIG. 2 schematically shows another example of the printing apparatus 100. The printing device 100 is similar to the one shown in FIG. 1 and further comprises an auxiliary heating device 106 to provide heat to the print medium M upstream of the sublimation device 104. The auxiliary heating device 106 may be referred to as a first heating device or a pre-heating device, and the sublimation device 104 may be referred to as a second heating device. or a main heating device. Accordingly, the heating process by the sublimation device 104 may be referred to as a main heating process.

Here, upstream and downstream may refer to the printing or processing progress P. In some examples, the print medium M may be transported from the depositing device 102 to the sublimation device 104, and an upstream direction may be opposite to the transport direction of the print medium M, and a downstream direction may be along the transport direction of the print medium M. In other examples, the print medium M may not be moved between the depositing device 102 and the sublimation device 104, and the upstream may refer to prior to or before processing by the respective device, and downstream may refer to after processing by the respective device.

In some examples, the auxiliary heating device 106 may be arranged to provide heat downstream of the depositing device 102. In particular, the auxiliary heating device 106 may be arranged to provide heat upstream of the sublimation device 104 and downstream of the depositing device 102. The auxiliary heating device 106 may be arranged between the depositing device 102 and the sublimation device 104 in terms of an operation progress of the printing device 100. Accordingly, the heat provided by the auxiliary heating device 106 may increase temperatures of both of the print medium M and the sublimation agent of the print fluid F deposited on the print medium M.

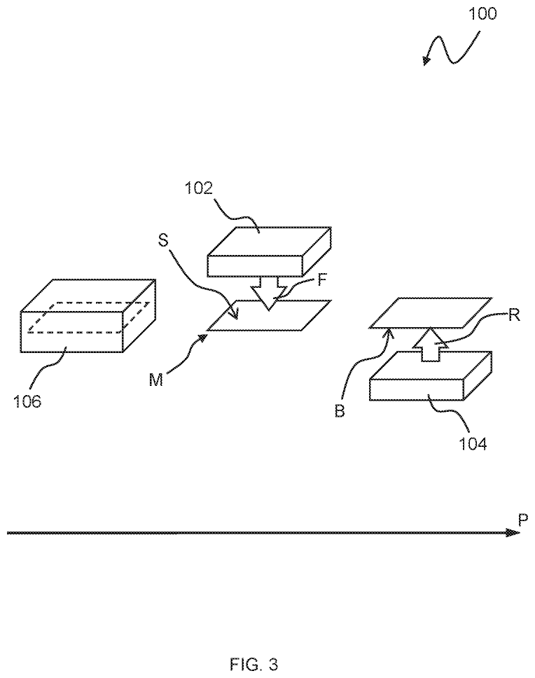

In further examples, as schematically shown in FIG. 3, the auxiliary heating device 106 may be arranged to provide heat upstream of the depositing device 102. Accordingly, the print medium may be heated to a temperature determined by the auxiliary heating device 106, and the print fluid F is deposited on the heated print medium M.

In some examples, the auxiliary heating device 106 may include two stages to provide heat to the print medium M upstream of the depositing device 102 and downstream of the depositing device 102 (not shown).

In addition or alternatively, the auxiliary heating device 106 may provide heat to print medium M simultaneously with operation of the depositing device 102, i.e. while the print fluid F is being deposited on the print medium M (not shown). For example, the auxiliary heating device 106 may be integrated in or overlap with the depositing device 102.

The auxiliary heating device 106 may provide heat such to increase an initial temperature of the print medium M and thus the sublimation agent, which receives heat from the print medium M by thermal conduction, prior to the exposure to the heat radiation R from the sublimation device 104. By this means, absorbance differences and thus temperature differences due to a non-uniform distribution of the sublimation agent over the print medium M may be attenuated. The heat provided by the auxiliary heating device 106 may be below the sublimation temperature. The heat provided by the auxiliary heating device 106 may not cause the sublimation agent of the print fluid F to sublimate. The auxiliary heating device 106 may provide heat to reduce the amount of heat which the sublimation device 104 is required to provide for the sublimation of the sublimation agent. The auxiliary heating device 106 may be arranged to apply heat to increase the temperature of the print medium M to about 40° C. to about 200° C., or about 50° C. to about 180° C., or about 60° C. to about 150° C.

In FIGS. 2 and 3, the auxiliary heating device 106 is illustrated in a general manner. The auxiliary device 106 may comprise at least one of a light source to generate heat radiation, a thermal conductor to transfer heat via thermal conduction, or a fluid stream generator to provide thermal convection. The heating process by the auxiliary heating device 106 may differ from the heating process by the sublimation device 104 in the heating mechanism, or in at least one of wavelength, intensity and power of heating.

Moreover, while the auxiliary heating device 106 is illustrated in a general manner in FIGS. 2 and 3, the auxiliary heating device 106 may be arranged such to provide heat on a side facing the surface S of the print medium M. Additionally or alternatively, the auxiliary device 106 may be arranged such to provide heat on a side facing the backside B of the print medium M.

In examples where the auxiliary heating device 106 provides heat by heat radiation, the auxiliary heating device 106 may comprise a light source to generate heat radiation in the wavelength range of at least one of ultraviolet, infrared, near-infrared and visible light, or any combination thereof. With both the sublimation device 104 and the auxiliary heating device 106 comprising heat radiation devices, they may differ in at least one of parameters such as a wavelength range, an intensity, a power or a duration of the generated heat radiation. For example, the sublimation device 104 may provide heat radiation in a different wavelength range than the auxiliary heating device. Alternatively or additionally, the auxiliary heating device 106 may be arranged on the surface side S, while the sublimation device 104 is arranged on the backside B of the print medium M.

In examples where the auxiliary heating device 106 provides heat by thermal conduction, the auxiliary heating device 106 may comprise a solid body thermally coupled to a heat reservoir. For example, the auxiliary heating device 106 may comprise a plate or a roller to support the print medium M. A thermal fluid, such as a hot oil, may be supplied to a circuit that is thermally coupled to the auxiliary heating device 106, for example via a thermal exchanger. The auxiliary heating device 106 may further comprise a press (not shown) to press the print medium M against the solid body of the auxiliary heating device 106 in order to promote the heat transfer.

In examples where the auxiliary heating device 106 provides heat by thermal convection, the auxiliary heating device 106 may comprise an actuator to generate a stream of a hot fluid. For example, the hot fluid may include at least one of hot air, hot oil, hot water, hot steam, or a combination thereof. The actuator may be a pump, a vacuum generator, a ventilator, a fan, a blower, or the like. The auxiliary heating device 106 may be arranged to expose the print medium M to the hot fluid stream, thereby transferring heat to the print medium M. The auxiliary heating device 106 may generate the stream of the hot fluid in a direction perpendicular to either or both of the surface side S and backside B of the print medium M. Alternatively or additionally, the auxiliary heating device 106 may generate the stream in a direction parallel to either or both of the surface side S and backside B of the print medium M. The auxiliary heating device 106 may be arranged so to generate the stream of hot fluid having direction components both perpendicular and parallel to the sides S and B of the print medium M,

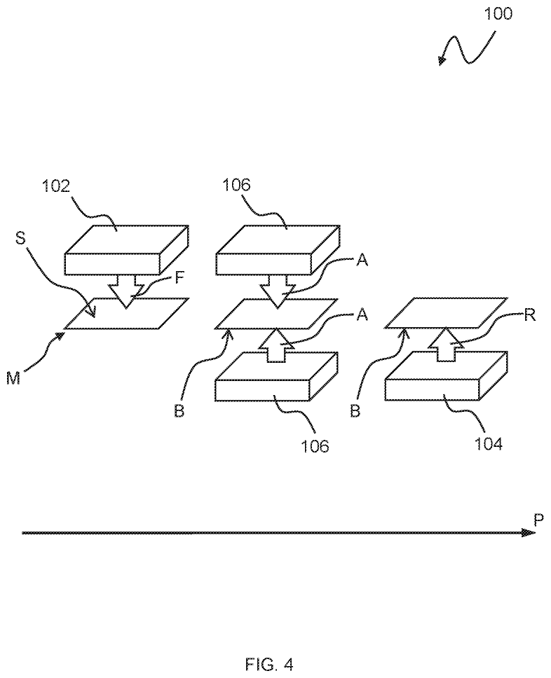

FIG. 4 schematically shows another example of the apparatus 100, wherein the auxiliary heating device 106 comprises a rotary press at a temperature A to transfer heat to the print medium M by means of thermal conduction. The rotary press may be thermally coupled to a heat reservoir (not shown) to be at the temperature A.

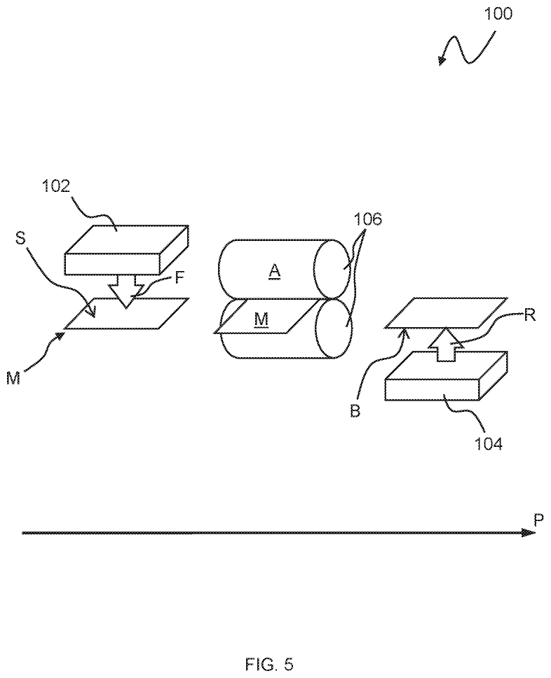

FIG. 5 schematically shows an example of the apparatus 100, wherein the auxiliary heating device 106 is depicted to be both on the first side S of the print medium M as well as on the second side B of the print medium M. This is illustrative and the auxiliary heating device 106 is not limited thereto. For example, the auxiliary heating device 106 may be located at least one of on the first side S, on the second side B and on both sides S and B of the print medium M. Additionally or alternatively, the auxiliary heating device 106 may be arranged to overlap a plane (not shown) in which the print medium M is disposed during the operation of the auxiliary heating device 106. Furthermore, the auxiliary heating device 106 may partially or entirely surround the print medium M.

The auxiliary heating device may comprise further heating means in addition (not shown). In some examples, the auxiliary heating device 106 is arranged to provide heat using two different heating mechanisms, both arranged on the same side, S or B (not shown), or one on either side as shown in FIG. 5. While the auxiliary heating device 106 is arranged downstream of the depositing device 102, the auxiliary heating device 106 may be in addition or alternatively arranged upstream of the depositing device 102 as shown in FIG. 3.

The auxiliary heating device 106 may provide heat A by means of heat radiation or thermal convection, which are both symbolized by arrows A in FIG. 5.

In FIG. 5, the arrows A are illustrated to be perpendicular to the respective side S or B of the print medium M, the auxiliary heating device 106 is not limited thereto. As described above, the auxiliary heating device 106 may be arranged to provide heat radiation or thermal convection in one or both of the directions that are depicted in FIG. 4. Additionally or alternatively, the auxiliary heating device 106 may be arranged to generate heat radiation or thermal convection having at least a component parallel to either or both of the surfaces S and B of the print medium.

By providing a separate auxiliary heating in any of the above described manner, the print medium M with or without the print fluid F deposited thereon may be at an increased temperature when being processed by the sublimation device 104, thereby decreasing the heat amount required to be provided by the sublimation device 104. Also, the auxiliary heating device 106 may contribute to further reducing the above-discussed non-uniformity of the temperature as a function of the type (color) of the sublimation agent or the thickness of the deposited sublimation agent.

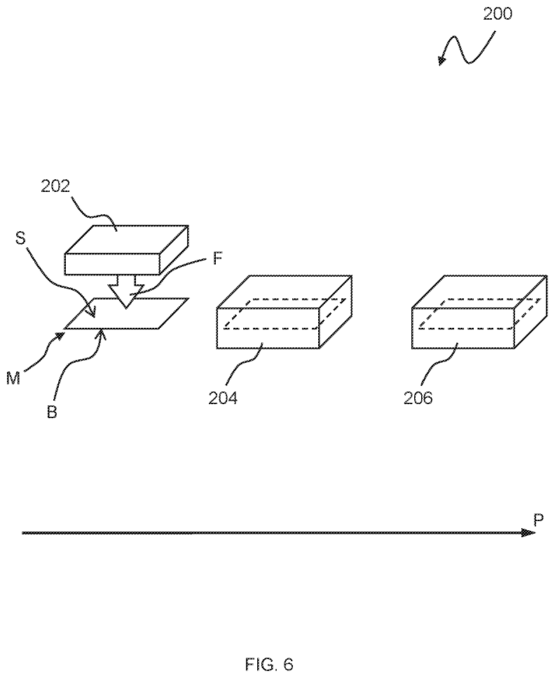

FIG. 6 schematically shows a printing apparatus 200 according to a further aspect. The printing apparatus 200 comprises a depositing device 202, a first heating device 204 and a second heating device 206. Unless otherwise indicated, the features described with respect to the printing apparatus 100, the auxiliary heating device 106 and the sublimation device 104 may apply to the printing apparatus 200, the first heating device 204 and the second heating device 206, respectively. Similarly, the features described below with respect to the printing apparatus 200, the first heating device 204 and the second heating device 206 may apply to the printing apparatus 100, the auxiliary heating device 106 and the sublimation device 104, respectively, unless otherwise indicated.

The depositing device 202 may be similar or identical to what has been described with respect to the depositing device 102. In particular, the depositing device 202 may deposit the print fluid F on the surface S of a substrate. The substrate may correspond to the print medium M as described above, and unless otherwise indicated, the features of the print medium M as described above may apply to the substrate accordingly. The print fluid F comprises a sublimation agent to sublimate at the sublimation temperature as described above. The operational progress is indicated by the arrow P.

The first heating device 204 is arranged to heat the substrate M to a first temperature. The first temperature is below the sublimation temperature of the sublimation agent of the print fluid F. As discussed above with respect to the auxiliary heating device 106, the first heating device 204 may provide heat by at least one of heat radiation, thermal conduction or thermal convection, or any combination thereof. The first heating device 204 may comprise at least one of a heat radiator, a heat exchanger, a heat conductor or a heat convector, or a combination thereof.

The heat radiator may comprise a device, such as a light source, to generate heat radiation. The heat exchanger may comprise a solid, thermally conductive body separating two closed circuits for exchanging heat without mixing. Herein, a material may be considered as thermally conductive or as a heat conductor, when the material has a thermal conductivity of 1.0 W/(mK) or more, 3 W/(mK) or more, or 10 W/(mK) or more, at atmospheric pressure and at a temperature of 273 K. The heat convector may comprise an actuator, such as a blower, fan, ventilator, pump or vacuum generator, to generate a stream of a fluid.

The second heating device 206 is arranged downstream of the depositing device 202 and is operable to heat the substrate M to a second temperature. The second temperature is at or above the sublimation temperature of the sublimation agent of the print fluid F. In particular, the second heating device 206 is arranged to provide the sublimation heat to sublimate the sublimation agent of the print fluid F deposited on the substrate M.

The first heating device 204 may be arranged upstream of the second heating device 206. The first heating device 204 may be arranged upstream or downstream of the depositing device 202 as described above with respect to the auxiliary heating device 106.

The first heating device 204 may be referred to as the pre-heating device to perform the pre-heating process as described above. In particular, the first heating device 204 may be arranged to increase the temperature of the substrate M to the first temperature above the room temperature, for example to about 40° C. to about 200° C., or about 50° C. to about 180° C., or about 60° C. to about 150° C. Accordingly, the first temperature may be such as not to cause the sublimation agent of the print fluid F to sublimate. Yet, the first heating device 204 may provide heat to reduce the heat amount which the second heating device 206 is required to provide for the sublimation of the sublimation agent. Also, the first heating device 204 may contribute to further reducing a non-uniformity of the temperature resulting from a variable absorbance depending on the type (color) of the sublimation agent or the thickness of the deposited sublimation agent as discussed above.

The second heating device 206 is not limited to a specific type of heat transfer. In some examples, the second heating device 206 may be arranged to generate and apply heat radiation to the substrate M, and the heat radiation may correspond to the above described heat radiation R of the sublimation device and may be directed from the backside B towards the surface S of the substrate M. In addition or alternatively to the heat radiation, the second heating device 206 may heat the substrate M to the second temperature by heat conduction, heat convection, or any combination thereof.

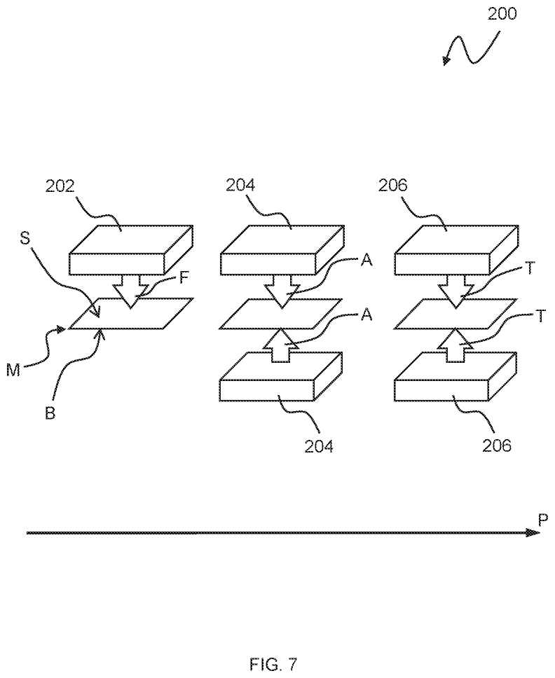

FIG. 7 schematically shows an example of the printing apparatus 200, where the first heating device 204 and the second heating device 206 may each comprise a heat radiator or thermal convector. Arrows A indicate the heat radiation or the thermal convection generated by the first heating device 204. Arrows T indicate the heat radiation or the thermal convection generated by the second heating device 206.

While the heat radiation or the thermal convection A of the first heating device 204 is illustrated to be provided on both sides S and B of the substrate M in FIG. 7, the first heating device 204 may be arranged on one of the sides S and B of the substrate M. Furthermore, while the heat radiation or the thermal convection T of the second heating device 206 is illustrated to be provided on both sides S and B of the substrate M in FIG. 7, the second heating device 206 may be arranged on one of the sides S and B of the substrate M. The first heating device 204 and the second heating device 206 may be provided on the same side S, B or opposite to each other.

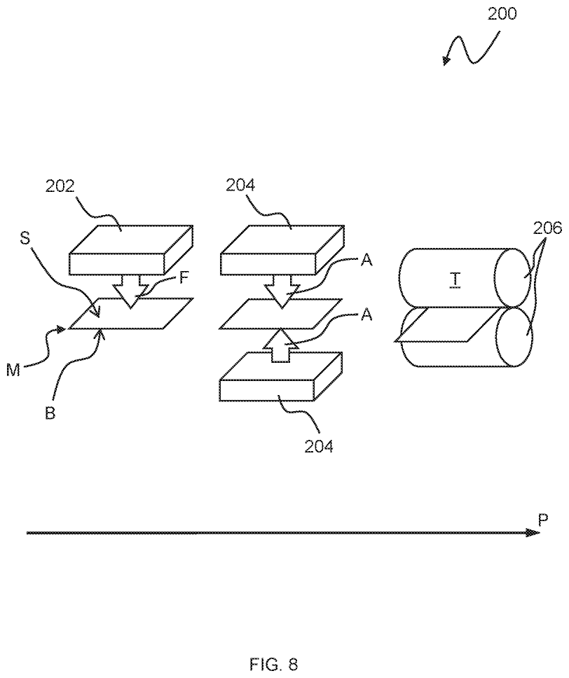

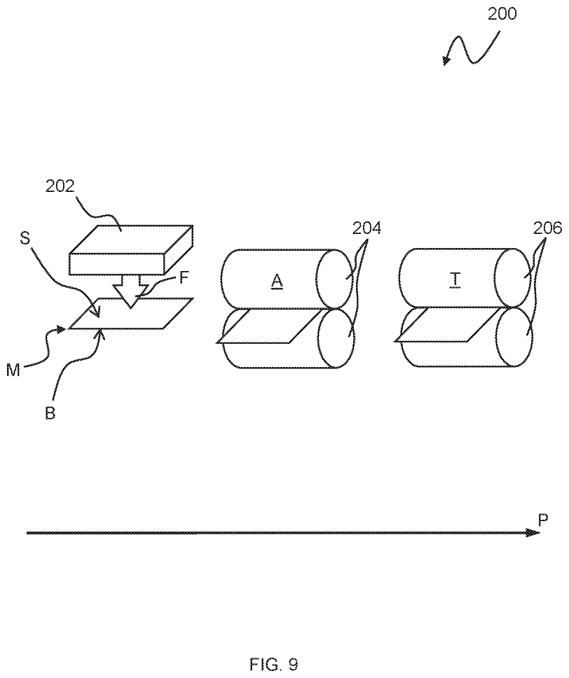

As shown in FIG. 7 and also in FIG. 8 below, the first heating device 204 may provide heat by means of heat radiation or thermal convection, which are both symbolized by arrows A in FIGS. 7 and 8 similar to FIG. 4 above. FIG. 9 schematically shows another example of the apparatus 200, wherein the first heating device 204 comprises a rotary press at a temperature A to transfer heat to the print medium M by means of thermal conduction. The rotary press may be thermally coupled to a heat reservoir (not shown) to be at or above the temperature A.

In FIGS. 7 and 8, arrows A are illustrated perpendicular to the respective side S or B of the print medium M, the first heating device 204 is not limited thereto. As described above with reference to FIG. 4, the first heating device 204 may be arranged to provide heat radiation or thermal convection in one or both of the directions A of FIGS. 7 and 8. Additionally or alternatively, the first heating device 204 may be arranged to generate heat radiation or thermal convection having at least a component parallel to either or both of the surfaces S and B of the print medium M.

Similar considerations may apply to the heat radiation or thermal convection of the second heating device 206 as indicated with the arrow T in FIG. 7. In FIG. 7, the direction of the application of heat is illustrated perpendicular on and to both the surface S and the backside B of the print medium M, with the second heating device 206 being arranged at both of the surface side S and the backside B of the print medium M. Alternatively or additionally, the second heating device 204 may be arranged at one of the surface side S and the backside B of the print medium M. Further, the second heating device 206 may generate the heat radiation or thermal convection T to have at least a component parallel to the surface side S or the backside B of the print medium M.

FIG. 8 schematically shows another example of the printing device 200. The second heating device 206 may comprise a thermal conductor including a rotary press at the second temperature T. The substrate M may be guided between two drums, one being the rotary press and the other pressing the substrate M against the rotary press. The rotary press may be thermally coupled to a thermal reservoir, for example via a heat exchanger.

FIG. 9 schematically shows a further example of the printing device 200, in which the first heating device 204 and the second heating device 206 each comprise a thermal conductor. The thermal conductor of any of the first heating device 204 and the second heating device 206 may comprise a rotary press as described above. The thermal conductor of the first heating device 204 may be as described above with reference to FIG. 5 and thermally coupled to a thermal reservoir to be at the first temperature A. The second heating device 206 may be as described above with reference to FIG. 8.

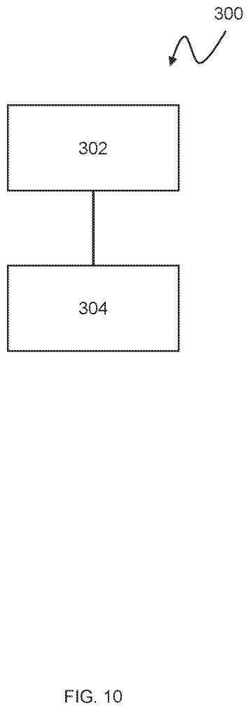

FIG. 10 is a schematic flow diagram of a method 300. The method may be executable in connection with any of the above described examples of the printing device 100 and the printing device 200.

At 302, a print fluid F is deposited on a surface S of a print medium M. The print fluid F contains a sublimation agent to sublimate at a sublimation temperature. The print fluid F and the sublimation agent may be as described above with reference to FIG. 1 to 9. The sublimation temperature may be at about 150° C. to about 400° C., or about 180° C. to about 300° C., or about 200° C. to 280° C. The print medium M may be interchangeably used with substrate. The print medium M may have the surface S, referred to as a first surface, on which the print fluid F is deposited. A surface on the opposite side of the print medium M may be referred to as a backside B.

At 304, sublimation heat is applied to the print medium M to sublimate the sublimation agent deposited on the print medium M. The sublimation heat may be applied by heat radiation propagating through the backside B opposite to the surface S of the print medium M towards the surface S of the print medium M. This may refer to the examples described above with reference to in FIG. 1 to 5 and may also applicable to FIGS. 6 and 7.

Additionally or alternatively, the sublimation heat may be applied by a preheating process and a subsequent main heating process. In the pre-heating process, temperature of the print medium M may be increased to a temperature below the sublimation temperature of the sublimation agent of the print fluid F. In the main heating process, the temperature of the print medium M, with the print fluid deposited thereon, may be increased to be at or above the sublimation temperature of the print fluid F. The pre-heating process and the main heating process differs from each other in mechanism of heating, power of heating, or at least one of wavelength and intensity, if both apply heat radiation. This may refer to the example described above with reference to in FIG. 2 to 9.

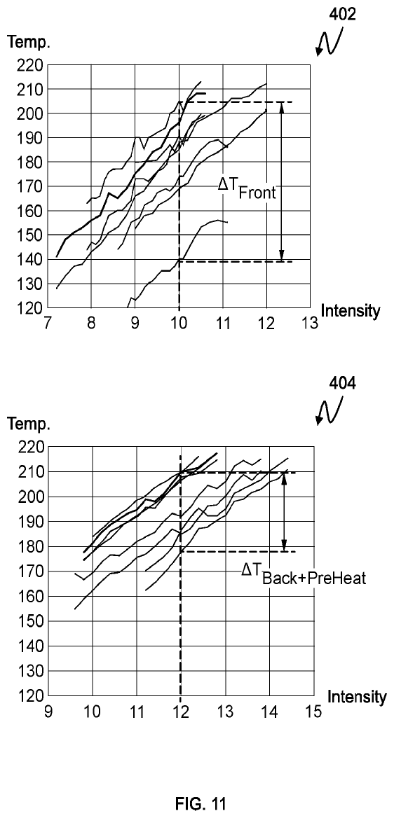

FIG. 11 shows diagrams of temperatures of different types of sublimation agents after exposure to different heating mechanisms. The horizontal axes indicate an intensity of the heat radiation applied in any arbitrary unit. The vertical axes indicate a final temperature in degree C. that is obtained after an exposure to the respective heat radiation for 1 second. In diagram 402, sublimation agents of different colors are deposited on the surface S of the print medium M and are exposed to heat radiation generated at the surface side S. In diagram 404, sublimation agents of the same different colors are deposited on the surface of the print medium M, heat radiation is generated on the backside B of the print medium M, and in addition, an auxiliary heating (pre-heat) is applied prior to the exposure to the backside heat radiation.

In FIG. 11, a respective temperature difference ΔT between different sublimation agents corresponding to different colors are indicated. In the diagram 402, the temperature difference ΔT_Front between the sublimation agents of the highest temperature and lowest temperature is approximately 65 degrees at an intensity of m units. In comparison, in the diagram 404, the temperature difference ΔT_Back+PreHeat between the sublimation agents of the highest temperature and lowest temperature is approximately 35 degrees at an intensity of 12 units.

Accordingly, it is shown that the uniformity of the temperature distribution over the print medium M may be achieved from applying the above described heat radiation from the backside of the print medium, and alternatively or additionally, the above described auxiliary heating (pre-heating, first heating). As a result, the quality of the image printed on the print medium M may be increased.

1. A printing apparatus, comprising:
a depositing device to deposit a print fluid on a first surface of a print medium, wherein the print fluid comprises a sublimation agent to sublimate at a sublimation temperature; and
a sublimation device to sublimate the sublimation agent deposited on the print medium by generating heat radiation in a direction from a second surface of the print medium towards the first surface, the second surface being opposite to the first surface.

2. The printing apparatus of claim 1, further comprising:
an auxiliary heating device to provide heat to the print medium upstream of the sublimation device.

3. The printing apparatus of claim 2,
wherein the auxiliary heating device is to provide heat downstream of the depositing device.

4. The printing apparatus of claim 1,
wherein the sublimation device comprises at least one of an ultraviolet light source and an infrared light source to generate the heat radiation.

5. The printing apparatus of claim 1,
wherein the sublimation device is to sublimate the sublimation agent through a transition between a solid phase and a gas phase at a temperature of about 50° C. to about 400° C.

6. A printing apparatus, comprising:
a depositing device to deposit a print fluid on a substrate, wherein the print fluid comprises a sublimation agent to sublimate at a sublimation temperature;
a first heating device to heat the substrate to a first temperature below the sublimation temperature; and
a second heating device to heat the substrate to a second temperature at or above the sublimation temperature, the second heating device arranged downstream of the depositing device.

7. The printing apparatus of claim 6,
wherein the second heating device is to generate and apply heat radiation to the substrate.

8. The printing apparatus of claim 6,
wherein the first heating device comprises at least one of a heat radiator, a heat exchanger, a heat conductor, or a heat convector, or a combination thereof.

9. A method, comprising:
depositing a print fluid on a surface of a print medium, the print medium containing a sublimation agent to sublimate at a sublimation temperature;
applying sublimation heat to the print medium to sublimate the sublimation agent deposited thereon, wherein the sublimation heat is applied by at least one of:
heat radiation propagating through a backside opposite to the surface of the print medium towards the surface of the print medium; and
a pre-heating process of increasing temperature of the print medium to a temperature below the sublimation temperature, and a subsequent main heating process of increasing the temperature of the print medium with the print fluid deposited thereon at or above the sublimation temperature of the print fluid, wherein the pre-heating and the main heating processes differ from each other in at least one of: mechanism, wavelength, intensity and power of heating.

10. The method of claim 9,
wherein the main heating process generates the heat radiation at the backside such that the heat radiation propagates towards the surface of the print medium.

11. The method of claim 9,
wherein the pre-heating process is executed before depositing the print fluid on the print medium.

12. The method of claim 9,
wherein the pre-heating process is executed prior to depositing the print fluid on the surface of the print medium.

13. The method of claim 9,
wherein the print medium is exposed to the main heating process for a duration of 1 millisecond to 10 seconds,
wherein the print medium is exposed to the pre-heating process for a duration of 1 to 100 seconds.

14. The method of claim 9, wherein applying the sublimation heat comprises at least one of:
the pre-heating increasing the temperature of the print medium to about 40° C. to about 200° C., or about 50° C. to about 180° C., or about 60° C. to about 150° C.; and
the main heating process increasing the temperature of the print medium to about 150° C. to about 400° C., or about 180° C. to about 300° C., or about 200° C. to 280° C.

15. The method of claim 9,
wherein the sublimation heat is applied such that a first portion of the sublimation heat is transferred to the sublimation agent deposited on the print medium via heat radiation, and a second portion of the sublimation heat is transferred to the sublimation agent deposited on the print medium via heat conduction.
